(19) United States
(12) Patent Application Publication
(10) Pub. No.: US 2014/0340623 A1
(43) Pub. Date: Nov. 20, 2014

(54) LIQUID CRYSTAL DISPLAY

(71) Applicant: Samsung Display Co., Ltd., Yongin-City (KR)

(72) Inventors: Hoon Kim, Ansan-si (KR); Ki Chul Shin, Seongnam-si (KR); Dan Bi Yang, Gunpo-si (KR)

(73) Assignee: Samsung Display Co., Ltd., Yongin-City (KR)

(21) Appl. No.: 14/273,212

(22) Filed: May 8, 2014

(30) Foreign Application Priority Data
May 16, 2013 (KR) 10-2013-0055990

(51) Int. Cl. G02F 1/1343; G02F 1/137

(52) U.S. Cl. CPC G02F 1/134309; G02F 1/137; G02F 2001/13706
USPC 349/138

(57) ABSTRACT

A liquid crystal display includes: a first substrate; a second substrate disposed opposite to the first substrate; a liquid crystal layer interposed between the first substrate and the second substrate, and including liquid crystal molecules; a first pixel electrode and a second pixel electrode, which are disposed on the first substrate, spaced apart from each other, and positioned in one pixel area; a common electrode disposed on the second substrate; and an insulating layer disposed on the common electrode, in which the liquid crystal molecules are aligned substantially vertical to a surface of the first substrate and a surface of the second substrate when an electric field is not applied thereto, and the liquid crystal molecules have positive dielectric anisotropy.

This application claims priority to Korean Patent Application No. 10-2013-0055990, filed on May 16, 2013, and all the benefits accruing therefrom under 35 U.S.C. §119, the content of which in its entirety is herein incorporated by reference.

### BACKGROUND

(a) Technical Field

Exemplary embodiments of the invention relates to a liquid crystal display.

(b) Description of the Related Art

A liquid crystal display, which is one of the most widely used types of flat panel display, typically includes two sheets of display panels with field generating electrodes such as a pixel electrode, a common electrode and the like, and a liquid crystal layer interposed therebetween. The liquid crystal display generates an electric field in the liquid crystal layer by applying a voltage to the field generating electrodes to determine alignment of liquid crystal molecules of the liquid crystal layer through the generated electric field and to control polarization of incident light, thereby displaying images.

The liquid crystal display may have a high contrast ratio, an excellent wide viewing angle, and a fast response speed to improve display quality thereof, and arrangement of liquid crystal molecules may be influenced by an external effect such as an external pressure.

### SUMMARY

Exemplary embodiments of the invention provide a liquid crystal display with high contrast ratio and wide viewing angle of the liquid crystal display, increasing a response speed of liquid crystal molecules, and substantially maintained display characteristic regardless of an effect such as pressure from the outside of the liquid crystal display.

An exemplary embodiment of the invention provides a liquid crystal display including: a first substrate; a second substrate disposed opposite to the first substrate; a liquid crystal layer interposed between the first substrate and the second substrate, and including liquid crystal molecules; a first pixel electrode and a second pixel electrode, which are disposed on the first substrate, spaced apart from each other, and positioned in one pixel area; a common electrode disposed on the second substrate; and an insulating layer disposed on the common electrode, in which the liquid crystal molecules are aligned substantially vertical to a surface of the first substrate and a surface of the second substrate when an electric field is not applied thereto, and the liquid crystal molecules have positive dielectric anisotropy.

In an exemplary embodiment, the first pixel electrode may include a plurality of first branch electrodes, and the second pixel electrodes may include a plurality of second branch electrodes, the plurality of first branch electrodes and the plurality of second branch electrodes may be alternately disposed with each other, and the first pixel electrode and the second pixel electrode may be disposed in a same layer.

In an exemplary embodiment, the liquid crystal display may further include an interlayer insulating layer disposed between the first pixel electrode and the second pixel electrode, in which the first pixel electrode may include a plurality of first branch electrodes, and the second pixel electrode may include a plurality of second branch electrodes, and the plurality of first branch electrodes and the plurality of second branch electrodes may be alternately disposed with each other.

In an exemplary embodiment, the first pixel electrode and the second pixel electrode may receive voltages having different polarities from each other.

In an exemplary embodiment, the liquid crystal display may further include an auxiliary electrode disposed below the first pixel electrode and the second pixel electrode; and an additional interlayer insulating layer disposed between the first pixel electrode and the second pixel electrode, and the auxiliary electrode.

In an exemplary embodiment, the auxiliary electrode may receive a voltage having a predetermined magnitude, which is different from a magnitude of a voltage applied to the common electrode.

In an exemplary embodiment, the auxiliary electrode may have a planar shape.

In an exemplary embodiment, the liquid crystal display may further include an interlayer insulating layer disposed between the first pixel electrode and the second pixel electrode, in which one of the first pixel electrode and the second pixel electrode may include a plurality of first branch electrodes, and the other of the first pixel electrode and the second pixel electrode may have a planar shape, and the plurality of branch electrodes may be disposed on the interlayer insulating layer.

Another exemplary embodiment of the invention provides a liquid crystal display, including: a first substrate; a second substrate disposed opposite to the first substrate; a liquid crystal layer interposed between the first substrate and the second substrate and including liquid crystal molecules; a first pixel electrode and a second pixel electrode, which are disposed on the first substrate, spaced apart from each other, and disposed in a same pixel area; and an interlayer insulating layer disposed between the first pixel electrode and the second pixel electrode, in which one of the first pixel electrode and the second pixel electrode includes a plurality of first branch electrodes, and the other of the first pixel electrode and the second pixel electrode has a planar shape, and the liquid crystal molecules are aligned substantially vertical to a surface of the first substrate and a surface of the second substrate when an electric field is not applied thereto, and the liquid crystal molecules have positive dielectric anisotropy.

According to exemplary embodiments of the invention, the liquid crystal display may have a high contrast ratio and a wide viewing angle with increased response speed of liquid crystal molecules, and effectively maintain display characteristic thereof regardless of an effect such as external pressure thereon.

### BRIEF DESCRIPTION OF THE DRAWINGS

The above and other features of the invention will become more apparent by describing in further detail exemplary embodiments thereof with reference to the accompanying drawings, in which;

FIG. 1 is a schematic cross-sectional view of an exemplary embodiment of a liquid crystal display according to the invention;

FIG. 2 is a diagram illustrating a voltage applied to a data line and a pixel of an exemplary embodiment of the liquid crystal display according to the invention;

FIG. 3 is a top plan view of an exemplary embodiment of the liquid crystal display according to the invention;

FIG. 4 is a cross-sectional view taken along line IV-IV′ of the liquid crystal display of FIG. 3;

FIG. 5 is a schematic cross-sectional view of an alternative exemplary embodiment of a liquid crystal display according to the invention;

FIG. 6 is a top plan view of an alternative exemplary embodiment of the liquid crystal display according to the invention;

FIG. 7 is a cross-sectional view taken along line VII-VII′ of the liquid crystal display of FIG. 6;

FIG. 8 is a schematic cross-sectional view illustrating another alternative exemplary embodiment of a liquid crystal display according to the invention;

FIG. 9 is a top plan view of another alternative exemplary embodiment of a liquid crystal display according to the invention;

FIG. 10 is a cross-sectional view taken along line X-X′ of the liquid crystal display of FIG. 9;

FIG. 11 is a schematic cross-sectional view illustrating another alternative exemplary embodiment of a liquid crystal display according to the invention;

FIG. 12 is a top plan view of another alternative exemplary embodiment of a liquid crystal display according to the invention;

FIG. 13 is a cross-sectional view taken along line XIII-XIII′ of the liquid crystal display of FIG. 12;

FIG. 14 is a schematic cross-sectional view illustrating a liquid crystal display according to another exemplary embodiment of the invention;

FIG. 15 is a top plan view of another alternative exemplary embodiment of a liquid crystal display according to the invention; and

FIG. 16 is a cross-sectional view taken along line XVI-XVI′ of the liquid crystal display of FIG. 15.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on,” “connected to” or “coupled to” another element or layer, the element or layer can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

Hereinafter, exemplary embodiments of the invention will be described in further detail with reference to the accompanying drawings.

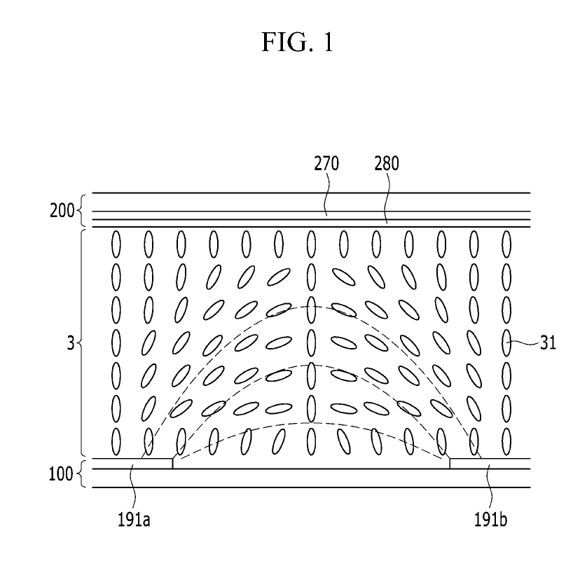

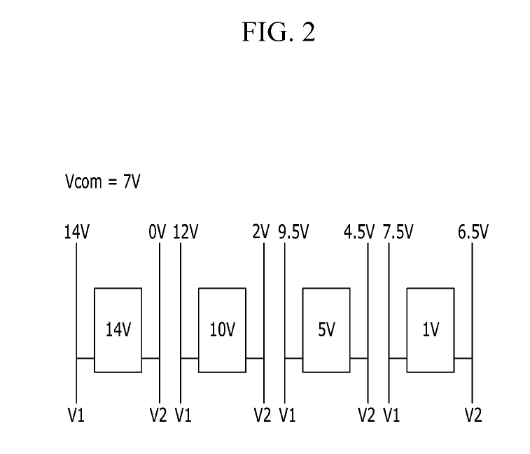

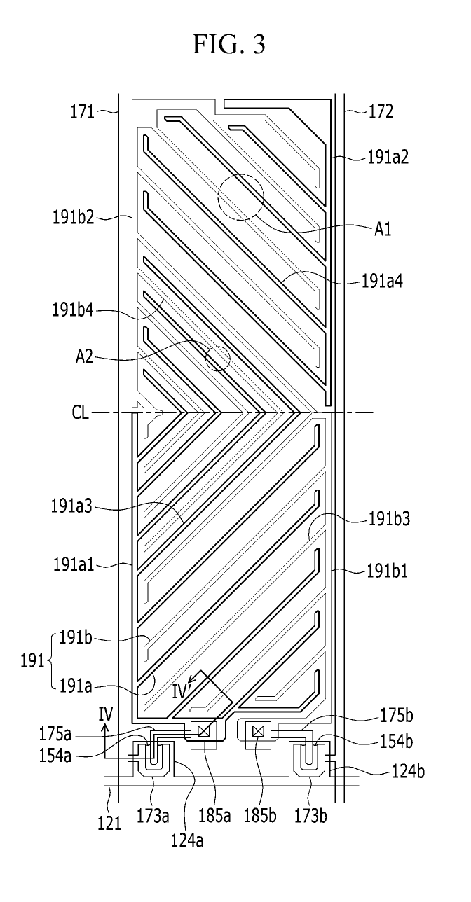

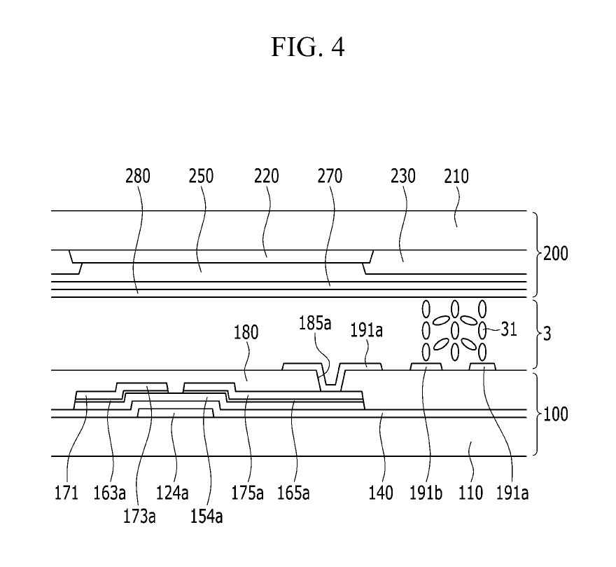

An exemplary embodiment of a liquid crystal display according to the invention will be described with reference to FIGS. 1 to 4. FIG. 1 is a schematic cross-sectional view of an exemplary embodiment of a liquid crystal display according to the invention, FIG. 2 is a diagram illustrating a voltage applied to data lines and a pixel of an exemplary embodiment of the liquid crystal display according to the invention, FIG. 3 is a top plan view of an exemplary embodiment of the liquid crystal display according to the invention, and FIG. 4 is a cross-sectional view taken along line IV-IV′ of the liquid crystal display of FIG. 3.

Referring to FIG. 1, an exemplary embodiment of a liquid crystal display includes two display panels, e.g., a lower panel 100 and an upper panel 200 disposed opposite to, e.g., facing, each other, and a liquid crystal layer 3 interposed between the two display panels 100 and 200.

In such an embodiment, a first pixel electrode 191a and a second pixel electrode 191b are disposed on the lower panel 100. The first pixel electrode 191a and the second pixel electrode 191b are disposed or positioned in a same pixel area, and the first pixel electrode 191a and the second pixel electrode 191b are disposed in the same layer and spaced apart from each other at a predetermined distance and insulated from each other. In such an embodiment, the first pixel electrode 191a and the second pixel electrode 191b may include a plurality of branch electrodes (not shown), which is disposed on the same layer and alternately disposed with each other.

In such an embodiment, a common electrode 270 is disposed on the upper panel 200, and an insulating layer 280 is disposed on the common electrode 270. The insulating layer 280 reduces an effect of a common voltage applied to the common electrode 270, and reduces an effect of the common voltage on a horizontal electric field applied between the first pixel electrode 191a and the second pixel electrode 191b.

In an exemplary embodiment, the liquid crystal layer 3 has positive dielectric anisotropy, and the liquid crystal molecules of the liquid crystal layer 3 are aligned in a predetermined direction such that longitudinal axes thereof are arranged substantially vertical to the surfaces of the two display panels 100 and 200 while an electric field is not applied.

Voltages having different polarities with respect to the common voltage applied to the common electrode 270 may be applied to the first pixel electrode 191a and the second pixel electrode 191b.

When different voltages are applied to the first pixel electrode 191a and the second pixel electrode 191b, a potential difference is generated between the first pixel electrode 191a and the second pixel electrode 191b, and as illustrated in FIG. 1, an electric field which is substantially parallel to the surface of the lower panel 100 is applied to the liquid crystal layer 3 between the first pixel electrode 191a and the second pixel electrode 191b. In such an embodiment, where liquid crystal molecules 31 have positive dielectric anisotropy, the liquid crystal molecules 31 are tilted such that longitudinal axes thereof are substantially parallel to a direction of the electric field, and the tilted degree varies according to a magnitude of a pixel voltage. In such an embodiment, a change degree of polarization of light passing through the liquid crystal layer 3 varies according to the tilted degree of the liquid crystal molecules 31. The change in the polarization is represented by a change in transmittance of light by a polarizer, and as a result, each pixel displays predetermined luminance corresponding to data voltage applied thereto.

As described above, in an exemplary embodiment, the liquid crystal molecules 31 of the liquid crystal layer 3 are aligned in a predetermined direction such that the longitudinal axes thereof are substantially vertical to the surfaces of the two display panels 100 and 200 while an electric field is not applied.

When different voltages are applied to the first pixel electrode 191a and the second pixel electrode 191b, the liquid crystal molecules 31 of the liquid crystal layer 3 are tilted to be substantially horizontal to the display panels 100 and 200.

However, the liquid crystal molecules 31, which are positioned at the same distance from the first pixel electrode 191a and the second pixel electrode 191b, and the liquid crystal molecules 31 which are positioned in areas corresponding to central portions of the first pixel electrode 191a and the second pixel electrode 191b may not be tilted to either side, and maintain an initially vertical alignment state, and as a result, a low luminance portion, which has luminance lower than ambient luminance, occurs.

In an exemplary embodiment, when the liquid crystal display displays luminance corresponding to a high grayscale level such as white, when an external pressure is applied thereto, the liquid crystal molecules 31 which are positioned the low luminance portion such as a region at the same distance from the first pixel electrode 191a and the second pixel electrode 191b and the central portions of the first pixel electrode 191a and the second pixel electrode 191b may be inclined substantially horizontal to the display panels 100 and 200 such that transmittance of the liquid crystal display may occur, and as a result, the low luminance portion may be recognized as a yellowish bruising. The yellowish bruising may disappear when the external pressure is removed and the liquid crystal molecules 31 are directly restored to a state before the external pressure is applied, but since the liquid crystal molecules 31 positioned around the low luminance portion are inclined, the liquid crystal molecules 31 positioned at the low luminance portion keep the inclined state due to an effect of an aligned state of the liquid crystal molecules 31 therearound and thus may not disappear over time.

In an exemplary embodiment, the liquid crystal display includes the common electrode 270 disposed on the upper panel 200, as illustrated in FIG. 1.

In such an embodiment, a vertical electric field may be applied between the common electrode 270 and the first pixel electrode 191a, and between the common electrode 270 and the second pixel electrode 191b.

Accordingly, in such an embodiment, the liquid crystal molecules 31 positioned on the first pixel electrode 191a and the second pixel electrode 191b are maintained in the vertical alignment state by the vertical electric field.

Accordingly, when the liquid crystal molecules 31 positioned in the area corresponding to the low luminance portion is in a horizontally inclined state by external pressure and the like, the liquid crystal molecules 31 positioned in the area corresponding to the low luminance portion may be restored to the vertical alignment state by the vertical electric field applied to the liquid crystal molecules 31 positioned on the first pixel electrode 191a and the second pixel electrode 191b such that recognition of the yellowish bruising due to external pressure and the like may be effectively removed.

In such an embodiment, when a horizontal electric field applied to the liquid crystal layer 3 is removed, the liquid crystal molecules 31 positioned around the low luminance portion are influenced by the vertical alignment state of the liquid crystal molecules 31 and thereby rapidly restored to the vertical alignment state again. Accordingly, the response speed of the liquid crystal display may be increased.

Referring to FIG. 2, magnitudes of voltages applied to the first pixel electrode 191a and the second pixel electrode 191b of each pixel of an exemplary embodiment of the liquid crystal display will be described.

FIG. 2 illustrates the voltages applied to the first pixel electrode 191a and the second pixel electrode 191b of each pixel of four pixels which are adjacent to each other in an exemplary embodiment of the liquid crystal display according to the invention when charged voltages of liquid crystal capacitors are about 14 volts (V), about 10 V, about 5 V and about 1 V, respectively, and when a minimum voltage and a maximum voltage which may be used by the liquid crystal display are about zero (0) V and about 14 V, respectively.

Different voltages having different polarities are applied to the first pixel electrode 191a and the second pixel electrode 191b with respect to a common electrode Vcom, and a difference between the two voltages becomes a pixel voltage of each pixel.

In one embodiment, for example, the common voltage Vcom is about 7 V. In such an embodiment, since a target pixel voltage of a first pixel is about 14 V, a first voltage V1 applied to the first pixel electrode 191a and a second voltage V2 applied to the second pixel electrode 191b may be about 14 V and about zero (0) V, respectively. Since a target pixel voltage of a second pixel is about 10 V, the first voltage V1 applied to the first pixel electrode 191a and the second voltage V2 applied to the second pixel electrode 191b may be about 12 V and about 2 V, respectively. Since a target pixel voltage of a third pixel is about 5 V, the first voltage V1 applied to the first pixel electrode 191a and the second voltage V2 applied to the second pixel electrode 191b may be about 9.5 V and about 4.5 V, respectively. Since a target pixel voltage of a fourth pixel is 1 V, the first voltage V1 applied to the first pixel electrode 191a and the second voltage V2 applied to the second pixel electrode 191b may be about 7.5 V and about 6.5 V, respectively.

The two voltages having different polarities with respect to the common voltage Vcom are applied to one pixel, and as a result, the magnitudes of the voltages applied to the first pixel electrode 191a and the second pixel electrode 191b are substantially reduced, a driving voltage may be increased, the response speed of the liquid crystal molecules may be increased, and transmittance of the liquid crystal display may be increased. In such an embodiment, since polarities of the two voltages applied to the first pixel electrode 191a and the second pixel electrode 191b of one pixel are opposite to each other, in an exemplary embodiment where an inversion type in the data driver is column inversion or row inversion, deterioration of image quality due to a flicker may be effectively prevented as in an exemplary embodiment where the inversion type in the data driver is dot inversion driving.

In one pixel of such an embodiment, when a first switching element and a second switching element, which are connected to the first pixel electrode 191a and the second pixel electrode 191b, are turned off, since all the voltages applied to the first pixel electrode 191a and the second pixel electrode 191b drop by a kickback voltage, the charged voltage of the pixel is effectively maintained, and the display characteristic of the liquid crystal display is thereby substantially improved.

A detailed structure of an exemplary embodiment of the liquid crystal display of FIG. 1 will be described in detail with reference to FIGS. 3 and 4.

Referring to FIGS. 3 and 4, an exemplary embodiment of the liquid crystal display device includes two display panels, e.g., a lower panel 100 and an upper panel 200, disposed opposite to, e.g., facing, each other, and a liquid crystal layer 3 interposed between the two display panels 100 and 200.

First, the lower panel 100 will be described.

In an exemplary embodiment, the lower panel 100 includes a first insulation substrate 110 and a gate line 121 disposed on the first insulation substrate 110.

In such an embodiment, the gate lines 121 transfer gate signals and extend substantially in a horizontal direction, and each gate line 121 includes a first gate electrode 124a and a second gate electrode 124b which protrude upward from an extending direction thereof.

The gate line 121 may have a single-layered structure or a multilayered structure.

A gate insulating layer 140 including silicon nitride (SiNx) or silicon oxide (SiOx) is disposed on the gate line 121.

A first semiconductor 154a and a second semiconductor 154b are disposed on the gate insulating layer 140. The first semiconductor 154a and the second semiconductor 154b may include hydrogenated amorphous or polycrystalline silicon, or may include an oxide semiconductor.

Ohmic contacts 163a and 165a are disposed on the first semiconductor 154a and the second semiconductor 154b. The ohmic contacts 163a and 165a may include a material such as n+ hydrogenated amorphous silicon, in which an n-type impurity such as phosphorus is doped at high concentration, or silicide.

In an exemplary embodiment where the first semiconductor 154a and the second semiconductor 154b include the oxide semiconductor, the ohmic contacts may be omitted.

In such an embodiment, a data conductor including a first data line 171 and a second data line 172, a first drain electrode 175a, and a second drain electrode 175b is disposed on the ohmic contacts 163a and 165a and the gate insulating layer 140.

The first data line 171 and the second data line 172 transfer data signals and extend substantially in a vertical direction crossing the gate line 121.

The first data line 171 includes a first source electrode 173a which is curved in a U-like shape toward the first gate electrode 124a, and the second data line 172 includes a second source electrode 173b, which is curved in a U-like shape toward the second gate electrode 124b.

In an exemplary embodiment of the liquid crystal display, the second source electrode 173b extends from the second data line 172. In an alternative exemplary embodiment, the second source electrode 173b may be connected to a voltage applying line that applies a constant voltage, and in such an embodiment, the liquid crystal display may include the voltage applying line, instead of the second data line 172.

The first gate electrode 124a, the first source electrode 173a and the first drain electrode 175a collectively define a first thin film transistor together with the first semiconductor 154a, and a channel of the first thin film transistor is formed in the first semiconductor 154a between the first source electrode 173a and the first drain electrode 175a. The second gate electrode 124b, the second source electrode 173b and the second drain electrode 175b collectively define a second thin film transistor together with the second semiconductor 154b, and a channel of the second thin film transistor is formed in the second semiconductor 154b between the second source electrode 173b and the second drain electrode 175b.

The data conductor 171, 172, 175a and 175b may have a single-layered structure or a multi-layered structure.

The ohmic contacts 163a and 165a is disposed in an overlapping region between the semiconductors 154a and 154b therebelow and the data conductor 171, 172, 175a and 175b thereabove, and decrease contact resistance therebetween. An exposed portion, which is not covered by the data conductor 171, 172, 175a and 175b, including a space between the source electrodes 173a and 173b and the drain electrodes 175a and 175b, is disposed at the semiconductors 154a and 154b and exposes a portion of the semiconductors 154a and 154b.

In such an embodiment, a passivation layer 180 made of an inorganic insulator or an organic insulator is disposed on the data conductor 171, 172, 175a, and 175b and the exposed portion of the semiconductors 154a and 154b.

In such an embodiment, a first contact hole 185a exposing the first drain electrode 175a and a second contact hole 185b exposing the second drain electrode 175b are defined in the passivation layer 180.

In such an embodiment, a pixel electrode 191 including the first pixel electrode 191a and the second pixel electrode 191b, which includes a transparent conductive material such as indium tin oxide (“ITO”) or indium zinc oxide (“IZO”) or reflective metal such as aluminum, silver, chromium, or an alloy thereof, is disposed on the passivation layer 180.

As illustrated in FIG. 3, an overall outer shape of the pixel electrode 191 is substantially a quadrangle, and the first pixel electrode 191a and the second pixel electrode 191b include a plurality of branches which engages with each other at a predetermined distance, and a stem which connects the plurality of branches.

The first pixel electrode 191a and the second pixel electrode 191b may be substantially reverse symmetric with respect to an imaginary lateral center line CL, and each of the first pixel electrode 191a and the second pixel electrode 191b are divided into upper and lower subregions with respect to the imaginary lateral center line CL.

In an exemplary embodiment, the first pixel electrode 191a includes a lower stem 191a1 and an upper stem 191a2, and a plurality of first branches 191a3 and a plurality of second branches 191a4, which extend from the lower stem 191a1 and the upper stem 191a2, respectively. In such an embodiment, the second pixel electrode 191b includes a lower stem 191b1 and an upper stem 191b2, and a plurality of third branches 191b3 and a plurality of fourth branches 191b4, which extend from the lower stem 191b1 and the upper stem 191b2, respectively.

The lower stem 191a1 and the upper stem 191a2 of the first pixel electrode 191a are disposed at a lower left side and an upper right side of the pixel electrode 191, respectively, and the lower stem 191b1 and the upper stem 191b2 of the second pixel electrode 191b are disposed at a lower right side and a upper left side of the pixel electrode 191, respectively.

Accordingly, magnitudes of parasitic capacitances, which is generated when the data line and the pixel electrode 191 disposed at the left side and the right side of the pixel electrode 191 overlap each other, may be substantially symmetric at the left side and the right side of the pixel electrode 191, and as a result, the magnitudes of parasitic capacitances of the first pixel electrode 191a and the second pixel electrode 191b and the two left and right signal lines may be substantially the same as each other, and a crosstalk defect generated by a difference between left and right parasitic capacitances is thereby effectively prevented.

An angle between the plurality of branches 191a3, 191a4, 191b3 and 191b4 of the first pixel electrode 191a and the second pixel electrode 191b, and the imaginary center line CL may be about 45 degrees.

The branches of the first and second pixel electrodes 191a and 191b engage with each other and are alternately disposed to form a combed shape. A low gray region, in which a distance A1 between the adjacent branches is relatively great, and a high gray region, in which a distance A2 between the adjacent branches is relatively small, are defined in the pixel electrode 191, and the low gray region is positioned in a lower portion and an upper portion of the high gray region. In an alternative exemplary embodiment, widths between the branches of the first pixel electrode 191a and the second pixel electrode 191b, which are adjacent to each other in the low gray region and the high gray region, and the widths between the branches may be variously changed. In an exemplary embodiment, an area of the high gray region may be smaller than an area of the low gray region. Further, a difference between a distance A1 between the branches adjacent to each other in the low gray region and a distance A2 between the branches adjacent to each other in the high gray region may be about 2 micrometers (μm) or more.

In an exemplary embodiment, the distance between the first pixel electrode 191a and the second pixel electrode 191b in a pixel may vary, and as a result, the inclined angle of the liquid crystal molecules 31 of the liquid crystal layer 3 may vary, and different luminance for a same image information may be displayed in the pixel. When the distance between the branches of the first pixel electrode 191a and the second pixel electrode 191b is set to a predetermined distance, an image viewed from the side may be substantially close to an image viewed from the front, such that side visibility is substantially improved, and transmittance is substantially increased.

In such an embodiment, where a pixel of the liquid crystal display includes the high gray region and the low gray region, an afterimage generated in the low gray may be prevented by controlling a ratio of the areas of the high gray region and the low gray region.

Next, the upper panel 200 will be described.

In an exemplary embodiment, as shown in FIG. 3, the upper panel 200 includes a second insulation substrate 210 including transparent glass or plastic, for example, and a light blocking member 220 disposed on the second insulation substrate 210. The light blocking member 220 blocks light leakage between the pixel electrodes 191, and an opening region facing the pixel electrode 191 is defined in the light blocking member 220.

A plurality of color filters 230 is disposed on the second insulation substrate 210 and the light blocking member 220. The color filters 230 are disposed substantially in an area surrounded by the light blocking member 220 and may be elongated along a column of the pixel electrode 191. Each color filter 230 may display one of primary colors such as three primary colors of red, green and blue, for example.

An overcoat 250 is disposed on the color filter 230 and the light blocking member 220. The overcoat 250 may include an insulator, e.g., an organic insulator, and effectively prevent the color filter 230 from being exposed, and provide a flat surface. In an alternative exemplary embodiment, the overcoat 250 may be omitted.

In an exemplary embodiment, a common electrode 270 is disposed on the overcoat 250, and an insulating layer 280 is disposed on the common electrode 270.

The insulating layer 280 reduces an effect of the common voltage on a horizontal electric field applied between the first pixel electrode 191a and the second pixel electrode 191b by reducing an effect of a common voltage applied to the common electrode 270.

Alignment layers (not illustrated) may be coated on inner surfaces of the lower panel 100 and the upper panel 200, and the alignment layer may be a vertical alignment layer. At least one of the alignment layer and the liquid crystal layer 3 may include a photopolymerized polymer layer.

Polarizers (not illustrated) may be provided on outer surfaces of the lower panel 100 and the upper panel 200.

The liquid crystal layer 3 interposed between the lower panel 100 and the upper panel 200 includes liquid crystal molecules 31 having positive dielectric anisotropy, and the liquid crystal molecules 31 may be aligned in a predetermined direction such that longitudinal axes thereof are substantially vertical to the surfaces of the two display panels 100 and 200 while an electric field is not applied therein.

When voltages having different polarities are applied to the first pixel electrode 191a and the second pixel electrode 191b, an electric field which is substantially horizontal to the surfaces of the display panels 100 and 200 is generated. Then, the liquid crystal molecules of the liquid crystal layer 3 which are aligned substantially vertical to the surfaces of the display panels 100 and 200 in the initial stage in respond to the electric field, and thus the longitudinal axes thereof are tilted in a horizontal direction corresponding to the direction of the electric field, and the change degree of polarization of incident light in the liquid crystal layer 3 varies according to a tilted degree of the liquid crystal molecules. The change in the polarization is represented by a change in transmittance, and as a result, the liquid crystal display displays an image.

As such, in an exemplary embodiment including the vertically aligned liquid crystal molecules 31, a contrast ratio of the liquid crystal display may be increased and a wide viewing angle may be implemented. In such an embodiment, two data voltages having different polarities with respect to the common voltage Vcom are applied to a pixel, and as a result, the driving voltage may be increased and the response speed may be increased. In such an embodiment, as described above, effect of the kickback voltage is effectively prevented, and as a result, a flicker phenomenon and the like may be effectively prevented.

In an exemplary embodiment, where the vertically aligned liquid crystal molecules 31 are disposed between the two display panels 100 and 200, a contrast ratio of the liquid crystal display may be increased and a wide viewing angle may be implemented. In such an embodiment, the liquid crystal layer 3 includes the liquid crystal molecules 31 having positive dielectric anisotropy, which have larger dielectric anisotropy and lower rotation viscosity than the liquid crystal molecules having negative dielectric anisotropy, thereby acquiring a rapid response speed.

In an exemplary embodiment, the liquid crystal molecules 31 positioned in the area corresponding to the central portion of the first pixel electrode 191a and the second pixel electrode 191b may maintain the vertical alignment state due to the effect of the electric field by the common electrode 270 disposed on the upper panel 200, and as a result, the liquid crystal molecules 31 may be rapidly restored to the vertical alignment state when the liquid crystal molecules 31 are substantially horizontally aligned by the effect such as external pressure. Accordingly, deterioration of display quality, which may occur between the first pixel electrode 191a and the second pixel electrode 191b, and in the low luminance portion such as the central portion of the first pixel electrode 191a and the second pixel electrode 191b may be effectively prevented, and the response speed of the liquid crystal display may be substantially increased.

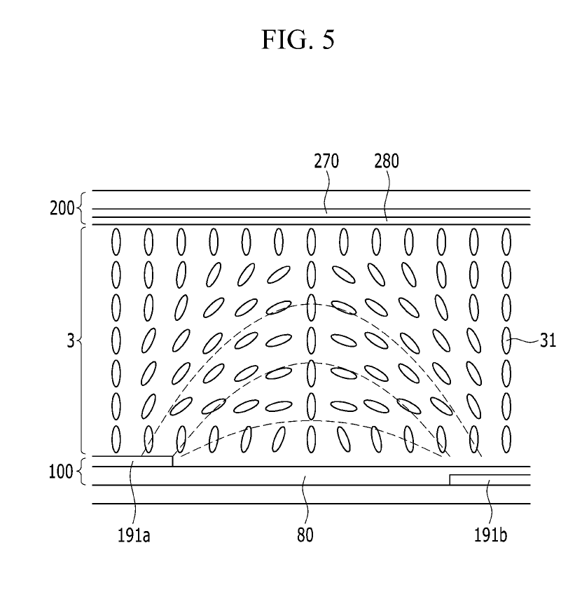

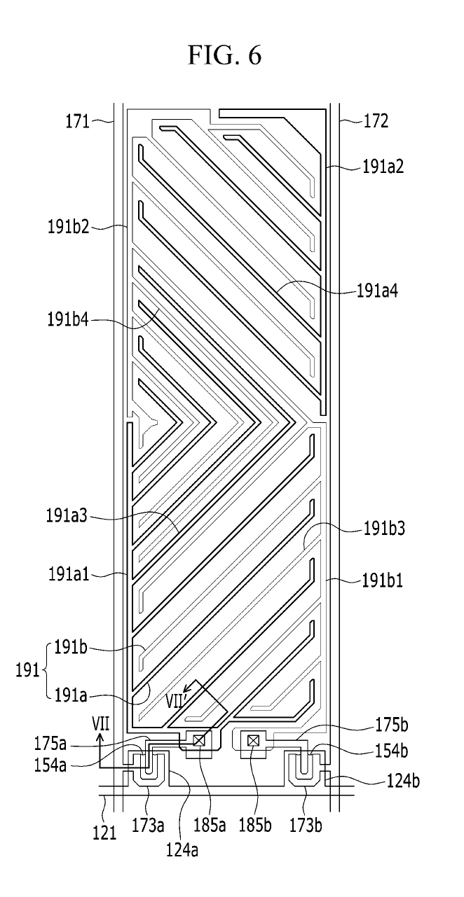

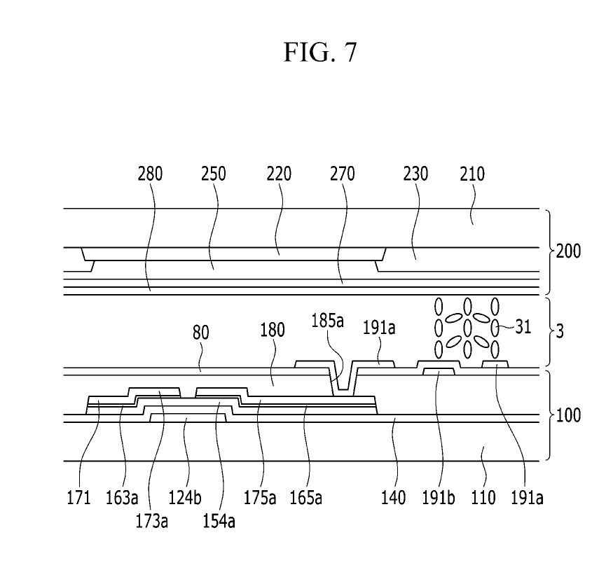

Then, an alternative exemplary embodiment of a liquid crystal display according to the invention will be described with reference to FIGS. 5 to 7. FIG. 5 is a schematic cross-sectional view of an alternative exemplary embodiment of a liquid crystal display according to the invention, FIG. 6 is a top plan view of an alternative exemplary embodiment of the liquid crystal display according to the invention, and FIG. 7 is a cross-sectional view taken along line VII-VII′ of the liquid crystal display of FIG. 6.

The liquid crystal display in FIGS. 5 to 7 is substantially the same as the liquid crystal display shown in FIGS. 1 to 4 except for an interlayer insulating layer 80. The same or like elements shown in FIGS. 5 to 7 have been labeled with the same reference characters as used above to describe the exemplary embodiments of the liquid crystal display shown in FIGS. 1 to 4, and any repetitive detailed description thereof may be omitted or simplified.

Referring to FIG. 5, an exemplary embodiment of a liquid crystal display includes two display panels, e.g., a lower panel 100 and an upper panel 200, disposed opposite to, e.g., facing, each other, and a liquid crystal layer 3 interposed between the two display panels 100 and 200.

In such an embodiment, a first pixel electrode 191a and a second pixel electrode 191b are disposed on the lower panel 100. The first pixel electrode 191a and the second pixel electrode 191b are disposed in each pixel area, and the first pixel electrode 191a and the second pixel electrode 191b are spaced apart from each other at a predetermined distance and insulated from each other. In such an embodiment, the first pixel electrode 191a and the second pixel electrode 191b may include a plurality of branch electrodes (not shown) which is disposed in the same layer and alternately disposed with each other.

A common electrode 270 is disposed on the upper panel 200, and an insulating layer 280 is disposed on the common electrode 270. The insulating layer 280 reduces an effect of a common voltage on a horizontal electric field applied between the first pixel electrode 191a and the second pixel electrode 191b by reducing the effect of the common voltage applied to the common electrode 270.

In such an embodiment, the liquid crystal layer 3 has positive dielectric anisotropy, and the liquid crystal molecules of the liquid crystal layer 3 are aligned in a predetermined direction such that longitudinal axes thereof are substantially vertical to the surfaces of the two display panels 100 and 200 while an electric field is not applied therein.

In an exemplary embodiment of the liquid crystal display as shown in FIG. 5, an interlayer insulating layer 80 may be further disposed between the first pixel electrode 191a and the second pixel electrode 191b.

In such an embodiment, the interlayer insulating layer 80 may be disposed below the first pixel electrode 191a and above the second pixel electrode 191b.

In such an embodiment, the interlayer insulating layer 80 is disposed between the first pixel electrode 191a and the second pixel electrode 191b, and as a result, during a process of providing the first pixel electrode 191a and the second pixel electrode 191b, shorts of the first pixel electrode 191a and the second pixel electrode 191b due to misalignment may be effectively prevented.

Voltages having different polarities with respect to the common voltage applied to the common electrode 270 may be applied to the first pixel electrode 191a and the second pixel electrode 191b.

In such an embodiment, when the different voltages are applied to the first pixel electrode 191a and the second pixel electrode 191b, a potential difference is generated between the first pixel electrode 191a and the second pixel electrode 191b, and as illustrated in FIG. 5, an electric field which is substantially parallel to the surface of the lower panel 100 is applied to the liquid crystal layer 3 between the first pixel electrode 191a and the second pixel electrode 191b. In such an embodiment, where liquid crystal molecules 31 have positive dielectric anisotropy, the liquid crystal molecules 31 are tilted such that longitudinal axes thereof are substantially parallel to a direction of the electric field, and the tilted degree varies according to a magnitude of a pixel voltage. In such an embodiment, a change degree of polarization of light passing through the liquid crystal layer 3 varies according to the tilted degree of the liquid crystal molecules 31. The change in the polarization is represented by a change in transmittance of light by a polarizer, and as a result, each pixel displays predetermined luminance corresponding to a data voltage applied thereto.

In an exemplary embodiment, the liquid crystal display includes the common electrode 270 disposed on the upper panel 200, as illustrated in FIG. 5.

A vertical electric field may be applied between the common electrode 270 and the first pixel electrode 191a, and between the common electrode 270 and the second pixel electrode 191b.

Accordingly, in such an embodiment, the liquid crystal molecules 31 positioned on the first pixel electrode 191a and the second pixel electrode 191b may be maintained in the vertical alignment state by the vertical electric field.

Accordingly, when the liquid crystal molecules 31 positioned in the area corresponding to a low luminance portion are in a horizontally inclined state by external pressure and the like, and the liquid crystal molecules 31 positioned in the area corresponding to the low luminance portion may be restored to the vertical alignment state again by the vertical electric field applied to the liquid crystal molecules 31 positioned on the first pixel electrode 191a and the second pixel electrode 191b. Therefore, recognition of the yellowish bruising due to external pressure and the like may be rapidly removed.

In such an embodiment, when a horizontal electric field applied to the liquid crystal layer 3 is removed, the liquid crystal molecules 31 positioned around the low luminance portion are influenced by the vertical alignment state of the liquid crystal molecules 31 and thereby rapidly restored to the vertical alignment state again. Accordingly, the response speed of the liquid crystal display may be increased.

A detailed structure of the embodiment of the liquid crystal display shown in FIGS. 6 and 7 is similar to a detailed structure of the exemplary embodiment of the liquid crystal display illustrated in FIGS. 3 and 4.

In an exemplary embodiment, as shown in FIGS. 6 and 7, the liquid crystal display includes two display panels, e.g., a lower panel 100 and an upper panel 200, disposed opposite to, e.g., facing, each other, and a liquid crystal layer 3 interposed between the two display panels 100 and 200.

First, the lower panel 100 will be described.

In an exemplary embodiment, the lower panel 100 includes a first insulation substrate 110, a gate line 121 including a first gate electrode 124a and a second gate electrode 124b and disposed on the first insulation substrate 110, and a gate insulating layer 140 is disposed on the gate line 121.

A first semiconductor 154a and a second semiconductor 154b are disposed on the gate insulating layer 140, ohmic contacts 163a and 165a are disposed on the first semiconductor 154a and the second semiconductor 154b, and a data conductor including a first data line 171, a second data line 172, a first drain electrode 175a and a second drain electrode 175b is disposed on the ohmic contacts 163a and 165a and the gate insulating layer 140. The first data line 171 includes a first source electrode 173a, and the second data line 172 includes a second source electrode 173b.

A passivation layer 180 including an inorganic insulator or an organic insulator is disposed on the data conductor 171, 172, 175a and 175b and an exposed portion of the semiconductors 154a and 154b, a second pixel electrode 191b is positioned on the passivation layer 180, an interlayer insulating layer 80 is disposed on the second pixel electrode 191b, and a first pixel electrode 191a is disposed on the interlayer insulating layer 80.

The first pixel electrode 191a is connected to the first drain electrode 175a through a first contact hole 185a defined through the passivation layer 180 and the interlayer insulating layer 80, and the second pixel electrode 191b is connected to the second drain electrode 175b through a second contact hole 185b defined through the passivation layer 180.

The first pixel electrode 191a includes a lower stem 191a1 and an upper stem 191a2, and a plurality of first branches 191a3 and a plurality of second branches 191a4, which extend from the lower stem 191a1 and the upper stem 191a2, respectively. In such an embodiment, the second pixel electrode 191b includes a lower stem 191b1 and an upper stem 191b2, and a plurality of third branches 191b3 and a plurality of fourth branches 191b4, which extend from the lower stem 191b1 and the upper stem 191b2, respectively.

Next, the upper panel 200 will be described.

In an exemplary embodiment, the upper panel 200 includes a second insulation substrate, a light blocking member 220 disposed on the second insulation substrate 210, a plurality of color filters 230 disposed on the second insulation substrate 210 and the light blocking member 220, and an overcoat 250 disposed on the color filter 230 and the light blocking member 220.

A common electrode 270 is disposed on the overcoat 250, and an insulating layer 280 is disposed on the common electrode 270.

In such an embodiment, the insulating layer 280 reduces an effect of the common voltage on a horizontal electric field applied between the first pixel electrode 191a and the second pixel electrode 191b by reducing an effect of a common voltage applied to the common electrode 270.

Alignment layers (not illustrated) may be disposed, e.g., coated, on inner surfaces of the lower panel 100 and the upper panel 200, and the alignment layer may be a vertical alignment layer. At least one of the alignment layer and the liquid crystal layer 3 may include a photopolymerized polymer layer.

Polarizers (not illustrated) may be provided on outer surfaces of the lower panel 100 and the upper panel 200.

The liquid crystal layer 3 interposed between the lower panel 100 and the upper panel 200 includes liquid crystal molecules 31 having positive dielectric anisotropy, and the liquid crystal molecules 31 may be aligned in predetermined direction such that longitudinal axes thereof are substantially vertical to the surfaces of the two display panels 100 and 200 while an electric field is not applied therein.

Other features of the exemplary embodiment of the liquid crystal display shown in FIGS. 5 to 7 are substantially the same as the exemplary embodiment described above with reference to FIGS. 1 to 4, and any repetitive detailed description thereof will hereinafter be omitted.

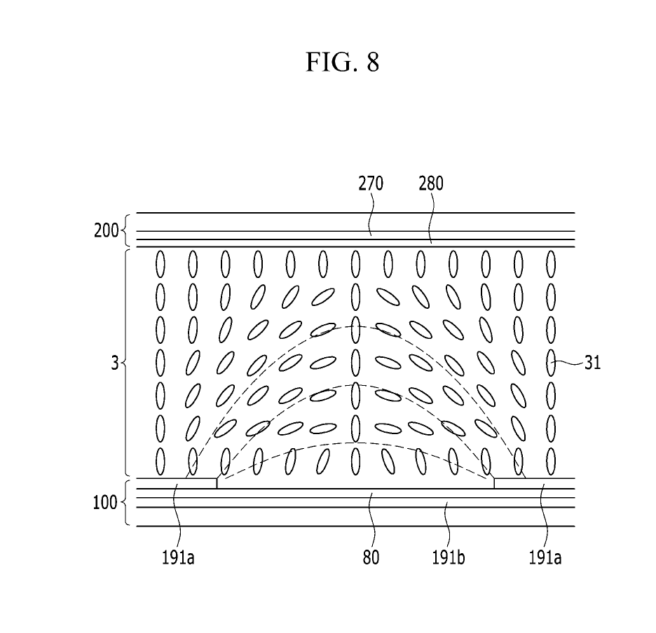

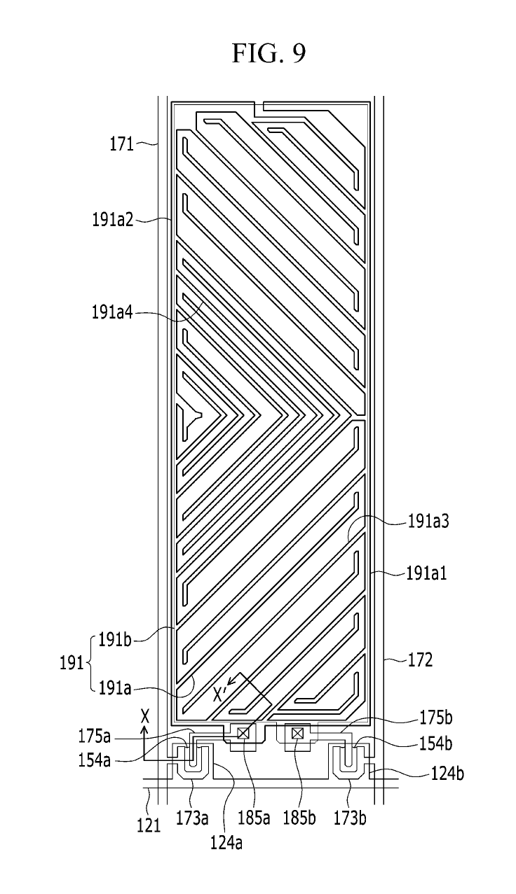

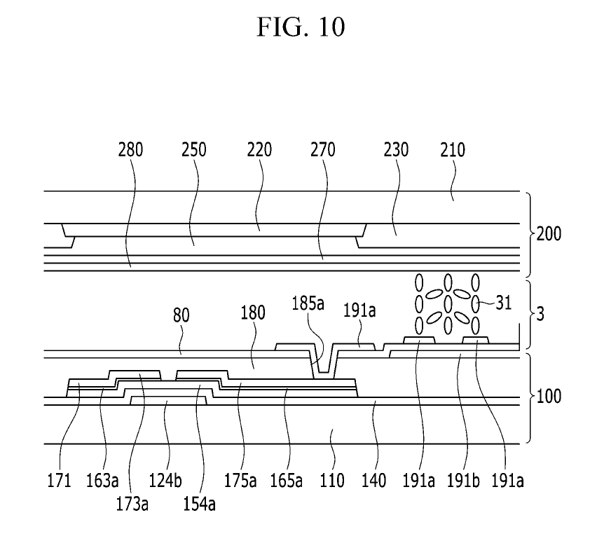

Then, another alternative exemplary embodiment of a liquid crystal display according to the invention will be described with reference to FIGS. 8 to 10. FIG. 8 is a schematic cross-sectional view of another alternative exemplary embodiment of a liquid crystal display according to the invention, FIG. 9 is a top plan view of another alternative exemplary embodiment of a liquid crystal display according to the invention, and FIG. 10 is a cross-sectional view taken along line X-X′ of the liquid crystal display of FIG. 9.

The liquid crystal display in FIGS. 8 to 10 is substantially the same as the liquid crystal display shown in FIGS. 5 to 7 except for the interlayer insulating layer 80. The same or like elements shown in FIGS. 8 to 10 have been labeled with the same reference characters as used above to describe the exemplary embodiments of the liquid crystal display shown in FIGS. 5 to 7, and any repetitive detailed description thereof may be omitted or simplified.

Referring to FIG. 8, an exemplary embodiment of a liquid crystal display includes two display panels, e.g., a lower panel 100 and an upper panel 200 facing each other, and a liquid crystal layer 3 interposed between the two display panels 100 and 200.

A first pixel electrode 191a and a second pixel electrode 191b are disposed on the lower panel 100. The first pixel electrode 191a and the second pixel electrode 191b are disposed in each pixel area.

In an exemplary embodiment, as shown in FIG. 8, the first pixel electrode 191a includes a plurality of branches, and the second pixel electrode 191b may have a planar shape disposed in the pixel area. In such an embodiment, the second pixel electrode 191b may substantially cover an entire pixel area. In such an embodiment, an interlayer insulating layer 80 is disposed between the first pixel electrode 191a and the second pixel electrode 191b. In one exemplary embodiment, for example, the interlayer insulating layer 80 may be positioned below the first pixel electrode 191a and above the second pixel electrode 191b.

A common electrode 270 is disposed on the upper panel 200, and an insulating layer 280 is disposed on the common electrode 270. The insulating layer 280 serves to reduce an effect of the common voltage on a horizontal electric field applied between the first pixel electrode 191a and the second pixel electrode 191b by reducing an effect of a common voltage applied to the common electrode 270.

The liquid crystal layer 3 has positive dielectric anisotropy, and the liquid crystal molecules of the liquid crystal layer 3 are aligned in a predetermined direction such that longitudinal axes thereof are substantially vertical to the surfaces of the two display panels 100 and 200 while an electric field is not applied therein.

In an exemplary embodiment, voltages having different polarities with respect to the common voltage applied to the common electrode 270 may be applied to the first pixel electrode 191a and the second pixel electrode 191b.

In such an embodiment, when the different voltages are applied to the first pixel electrode 191a and the second pixel electrode 191b, a potential difference is generated between the first pixel electrode 191a and the second pixel electrode 191b, and as illustrated in FIG. 8, an electric field which is substantially parallel to the surface of the lower panel 100 is applied to the liquid crystal layer 3 between the first pixel electrode 191a and the second pixel electrode 191b. In such an embodiment, where liquid crystal molecules 31 have positive dielectric anisotropy, the liquid crystal molecules 31 are tilted such that longitudinal axes thereof are substantially parallel to a direction of the electric field, and the tilted degree varies according to a magnitude of a pixel voltage. In such an embodiment, a change degree of polarization of light passing through the liquid crystal layer 3 varies according to the tilted degree of the liquid crystal molecules 31. The change in the polarization is represented by a change in transmittance of light by a polarizer, and as a result, each pixel displays predetermined luminance corresponding to data voltage applied thereto.

In an exemplary embodiment of the liquid crystal display, as shown in FIG. 8, the interlayer insulating layer 80 is disposed between the first pixel electrode 191a and the second pixel electrode 191b, and the first pixel electrode 191a includes a plurality of branches, and the second pixel electrode 191b has a planar shape. In such an embodiment, the interlayer insulating layer 80 may be disposed below the first pixel electrode 191a and above the second pixel electrode 191b.

In such an embodiment, the interlayer insulating layer 80 is disposed between the first pixel electrode 191a and the second pixel electrode 191b, and as a result, when the first pixel electrode 191a and the second pixel electrode 191b are provided, shorts of the first pixel electrode 191a and the second pixel electrode 191b due to misalignment may be effectively prevented.

In an exemplary embodiment, the liquid crystal display includes the common electrode 270 disposed on the upper panel 200, as illustrated in FIG. 8.

In such an embodiment, a vertical electric field may be applied between the common electrode 270 and the first pixel electrode 191a, and applied between the common electrode 270 and the second pixel electrode 191b.

Accordingly, in such an embodiment, the liquid crystal molecules 31 positioned on the first pixel electrode 191a and the second pixel electrode 191b are effectively maintained in the vertical alignment state by the vertical electric field.

Accordingly, when the liquid crystal molecules 31 positioned in the area corresponding to a low luminance portion is in a horizontally inclined state by external pressure and the like, the liquid crystal molecules 31 positioned in the area corresponding to the low luminance portion may be restored to the vertical alignment state again by the vertical electric field applied to the liquid crystal molecules 31 positioned on the first pixel electrode 191a and the second pixel electrode 191b. Therefore, recognition of the yellowish bruising due to external pressure and the like may be rapidly removed.

In such an embodiment, when a horizontal electric field applied to the liquid crystal layer 3 is removed, the liquid crystal molecules 31 positioned around the low luminance portion are influenced by the vertical alignment state of the liquid crystal molecules 31 and thereby rapidly restored to the vertical alignment state again. Accordingly, the response speed of the liquid crystal display may be increased.

Referring to FIGS. 9 and 10, a detailed structure of such an embodiment of the liquid crystal display is substantially similar to the detailed structures of the exemplary embodiment of the liquid crystal display illustrated in FIGS. 3 and 4, and the exemplary embodiment of the liquid crystal display illustrated in FIGS. 6 and 7.

In such an embodiment, the liquid crystal display includes two display panels, e.g., a lower panel 100 and an upper panel 200, disposed opposite to, e.g., facing, each other, and a liquid crystal layer 3 interposed between the two display panels 100 and 200.

First, the lower panel 100 will be described.

In an exemplary embodiment, the lower panel 100 includes a first insulation substrate 110. In such an embodiment, a gate line 121 including a first gate electrode 124a and a second gate electrode 124b is disposed on the first insulation substrate 110, and a gate insulating layer 140 is disposed on the gate line 121.

A first semiconductor 154a and a second semiconductor 154b are disposed on the gate insulating layer 140, ohmic contacts 163a and 165a are disposed on the first semiconductor 154a and the second semiconductor 154b, and a data conductor including a first data line 171, a second data line 172, a first drain electrode 175a and a second drain electrode 175b is disposed on the ohmic contacts 163a and 165a and the gate insulating layer 140. The first data line 171 includes a first source electrode 173a, and the second data line 172 includes a second source electrode 173b.

A passivation layer 180 including an inorganic insulator or an organic insulator is disposed on the data conductor 171, 172, 175a and 175b and an exposed portion of the semiconductors 154a and 154b, a second pixel electrode 191b is disposed on the passivation layer 180, an interlayer insulating layer 80 is disposed on the second pixel electrode 191b, and a first pixel electrode 191a is disposed on the interlayer insulating layer 80.

The first pixel electrode 191a is connected to the first drain electrode 175a through a first contact hole 185a defined through the passivation layer 180 and the interlayer insulating layer 80, and the second pixel electrode 191b is connected to the second drain electrode 175b through a second contact hole 185b defined through the passivation layer 180.

The first pixel electrode 191a includes a lower stem 191a1 and an upper stem 191a2, and a plurality of first branches 191a3 and a plurality of second branches 191a4, which extend from the lower stem 191a1 and the upper stem 191a2, respectively, and the second pixel electrode 191b has a planar shape.

Next, the upper panel 200 will be described.

In an exemplary embodiment, the upper panel 200 includes a second insulation substrate, a light blocking member 220 disposed on the second insulation substrate 210, a plurality of color filters 230 disposed on the second insulation substrate 210 and the light blocking member 220, and an overcoat 250 disposed on the color filter 230 and the light blocking member 220.

In such an embodiment, a common electrode 270 is disposed on the overcoat 250, and an insulating layer 280 is disposed on the common electrode 270.

The insulating layer 280 reduces an effect of the common voltage on a horizontal electric field applied between the first pixel electrode 191a and the second pixel electrode 191b by reducing an effect of a common voltage applied to the common electrode 270.

Alignment layers (not illustrated) may be coated on inner surfaces of the lower panel 100 and the upper panel 200, and the alignment layer may be a vertical alignment layer. At least one of the alignment layer and the liquid crystal layer 3 may include a photopolymerized polymer layer.

Polarizers (not illustrated) may be provided on outer surfaces of the lower panel 100 and the upper panel 200.

The liquid crystal layer 3 interposed between the lower panel 100 and the upper panel 200 includes liquid crystal molecules 31 having positive dielectric anisotropy, and the liquid crystal molecules 31 may be aligned in a predetermined direction such that longitudinal axes thereof are substantially vertical to the surfaces of the two display panels 100 and 200 while an electric field is not applied therein.

Other features of the exemplary embodiment of the liquid crystal display shown in FIGS. 5 to 7 are substantially the same as the exemplary embodiments shown in FIGS. 1 to 4 and FIGS. 5 to 7, and any repetitive detailed description thereof will hereinafter be omitted.

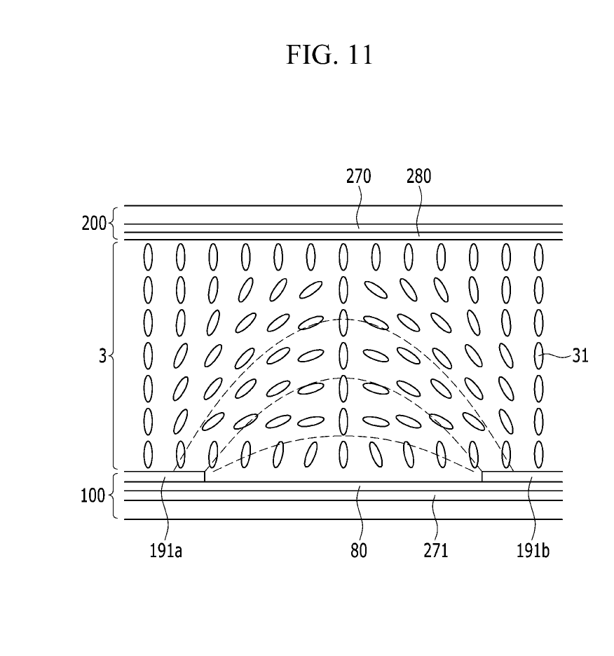

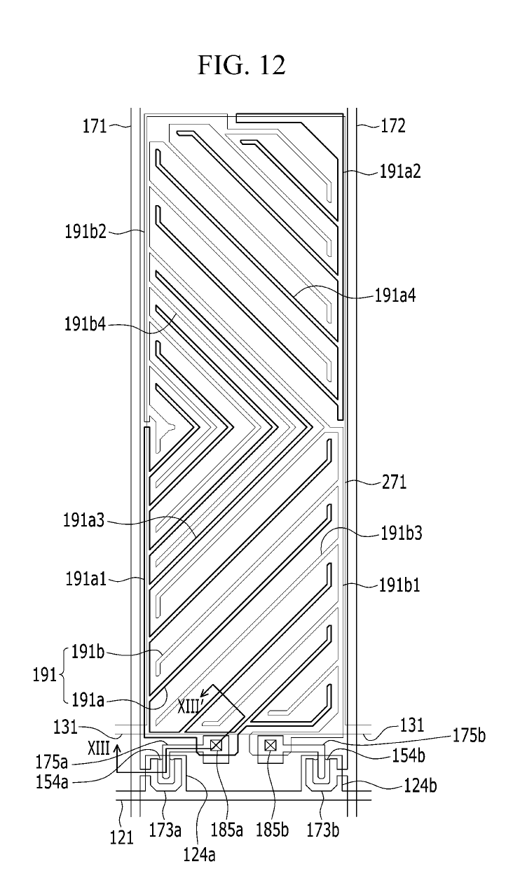

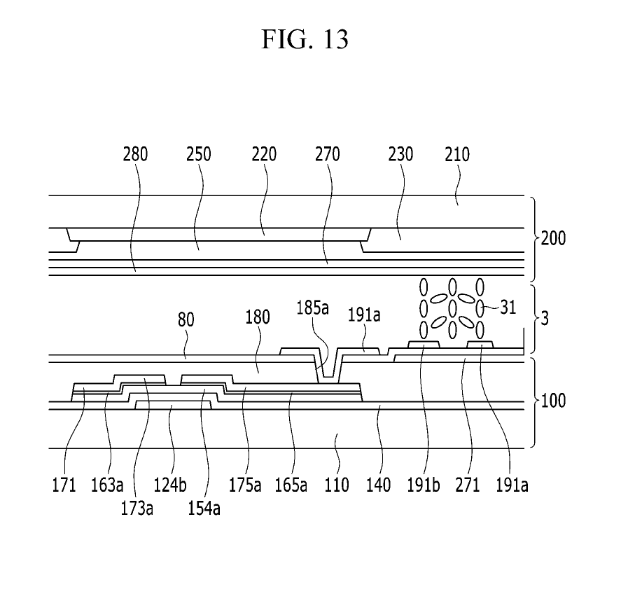

Then, another alternative exemplary embodiment of a liquid crystal display according to the invention will be described with reference to FIGS. 11 to 13. FIG. 11 is a schematic cross-sectional view of another alternative exemplary embodiment of a liquid crystal display according to the invention, FIG. 12 is a top plan view of another alternative exemplary embodiment of a liquid crystal display according to the invention, and FIG. 13 is a cross-sectional view taken along line XIII-XIII′ of the liquid crystal display of FIG. 12.

The liquid crystal display in FIGS. 11 to 13 is substantially the same as the liquid crystal display shown in FIGS. 1 to 4 except for the interlayer insulating layer 80 and an auxiliary electrode 271. The same or like elements shown in FIGS. 11 to 13 have been labeled with the same reference characters as used above to describe the exemplary embodiments of the liquid crystal display shown in FIGS. 1 to 4, and any repetitive detailed description thereof may be omitted or simplified.

Referring to FIG. 11, an exemplary embodiment of a liquid crystal display according to the invention includes two display panels, e.g., a lower panel 100 and an upper panel 200, disposed opposite to, e.g., facing, each other, and a liquid crystal layer 3 interposed between the two display panels 100 and 200.

In such an embodiment, a first pixel electrode 191a and a second pixel electrode 191b are disposed on the lower panel 100. The first pixel electrode 191a and the second pixel electrode 191b are positioned in each pixel area, and the first pixel electrode 191a and the second pixel electrode 191b are disposed in the same layer as and spaced apart from each other at a predetermined distance and insulated from each other. In an alternative exemplary embodiment, the first pixel electrode 191a and the second pixel electrode 191b may be disposed in different layers, and an insulating layer may be positioned between the first pixel electrode 191a and the second pixel electrode 191b. In an exemplary embodiment, the first pixel electrode 191a and the second pixel electrode 191b may include a plurality of branch electrodes (not shown), which is disposed in the same layer and alternately disposed with each other.

A common electrode 270 is disposed on the upper panel 200, and an insulating layer 280 is disposed on the common electrode 270. In such an embodiment, the insulating layer 280 reduces an effect of the common voltage on a horizontal electric field applied between the first pixel electrode 191a and the second pixel electrode 191b by reducing an effect of a common voltage applied to the common electrode 270.

The liquid crystal layer 3 has positive dielectric anisotropy, and the liquid crystal molecules of the liquid crystal layer 3 are aligned in a predetermined direction such that longitudinal axes thereof are substantially vertical to the surfaces of the two display panels 100 and 200 while an electric field is not applied therein.

In an exemplary embodiment of the liquid crystal display shown in FIGS. 11 to 13, an interlayer insulating layer 80 is disposed below the first pixel electrode 191a and the second pixel electrode 191b, and the auxiliary electrode 271 is disposed below the interlayer insulating layer 80.

The auxiliary electrode 271 may have a planar shape, and may substantially cover an entire pixel area.

A voltage having a predetermined magnitude, which is different from a magnitude of the common voltage applied to the common electrode 270, may be applied to the auxiliary electrode 271, and the auxiliary electrode 271 is connected to the auxiliary electrode 271 in an adjacent pixel area to receive the voltages having the same magnitude at the same time.

In an exemplary embodiment, voltages having different polarities with respect to the common voltage applied to the common electrode 270 may be applied to the first pixel electrode 191a and the second pixel electrode 191b.

In such an embodiment, when the different voltages are applied to the first pixel electrode 191a and the second pixel electrode 191b, a potential difference is generated between the first pixel electrode 191a and the second pixel electrode 191b, and as illustrated in FIG. 11, an electric field which is substantially parallel to the surface of the lower panel 100 is applied to the liquid crystal layer 3 between the first pixel electrode 191a and the second pixel electrode 191b. In such an embodiment, where liquid crystal molecules 31 have positive dielectric anisotropy, the liquid crystal molecules 31 are tilted such that longitudinal axes thereof are substantially parallel to a direction of the electric field, and the tilted degree varies according to a magnitude of a pixel voltage. In such an embodiment, a change degree of polarization of light passing through the liquid crystal layer 3 varies according to the tilted degree of the liquid crystal molecules 31. The change in the polarization is represented by a change in transmittance of light by a polarizer, and as a result, each pixel displays predetermined luminance corresponding to data voltage applied thereto.

In an exemplary embodiment, as shown in FIG. 11, the liquid crystal display includes the common electrode 270 disposed on the upper panel 200, and the auxiliary electrode 271 disposed on the lower panel 100.

In such an embodiment, a common voltage is applied to the common electrode 270, and a voltage having a predetermined magnitude, which is different from the magnitude of the common voltage applied to the common electrode 270, may be applied to the auxiliary electrode 271.

Therefore, a vertical electric field may be applied between the common electrode 270 and the first pixel electrode 191a, between the common electrode 270 and the second pixel electrode 191b, and between the common electrode 270 and the auxiliary electrode 271.

Accordingly, in such an embodiment, the liquid crystal molecules 31 positioned on the first pixel electrode 191a and the second pixel electrode 191b, and the liquid crystal molecules 31 positioned at the same distance from the first pixel electrode 191a and the second pixel electrode 191b are maintained in a vertical alignment state, by a vertical electric field between the first pixel electrode 191a and the second pixel electrode 191b and the common electrode 270, and a vertical electric field between the common electrode 270 and the auxiliary electrode 271.

Accordingly, when the liquid crystal molecules 31 positioned in the area corresponding to a low luminance portion is in a horizontally inclined state by external pressure and the like, the liquid crystal molecules 31 positioned in the area corresponding to the low luminance portion may be restored to the vertical alignment state again by the vertical electric fields applied to the liquid crystal molecules 31 positioned on the first pixel electrode 191a and the second pixel electrode 191b and the liquid crystal molecules 31 positioned at the same distance from the first pixel electrode 191a and the second pixel electrode 191b. Therefore, recognition of the yellowish bruising due to external pressure and the like may be rapidly removed.

In such an embodiment, when a horizontal electric field applied to the liquid crystal layer 3 is removed, the liquid crystal molecules 31 positioned around the low luminance portion are influenced by the vertical alignment state of the liquid crystal molecules 31 and thereby rapidly restored to the vertical alignment state again. Accordingly, the response speed of the liquid crystal display may be increased.

The structure of the exemplary embodiment of the liquid crystal display shown in FIGS. 12 and 13 is similar to the structure of the exemplary embodiment of the liquid crystal display illustrated in FIGS. 3 and 4.

In an exemplary embodiment, as shown in FIGS. 12 and 13, the liquid crystal display includes two display panels, e.g., a lower panel 100 and an upper panel 200, disposed opposite to, e.g., facing, each other, and a liquid crystal layer 3 interposed between the two display panels 100 and 200.

First, the lower panel 100 will be described.

In such an embodiment, the lower panel 100 includes a first insulation substrate 110, a gate line 121 including a first gate electrode 124a and a second gate electrode 124b and disposed on the first insulation substrate 110, and a gate insulating layer 140 disposed on the gate line 121.

A first semiconductor 154a and a second semiconductor 154b are disposed on the gate insulating layer 140, ohmic contacts 163a and 165a are disposed on the first semiconductor 154a and the second semiconductor 154b, and a data conductor including a first data line 171, a second data line 172, a first drain electrode 175a and a second drain electrode 175b is disposed on the ohmic contacts 163a and 165a and the gate insulating layer 140. The first data line 171 includes a first source electrode 173a, and the second data line 172 includes a second source electrode 173b.

A passivation layer 180 made of an inorganic insulator or an organic insulator is disposed on the data conductor 171, 172, 175a and 175b and the exposed portion of the semiconductors 154a and 154b, and an auxiliary electrode 271 connected to an auxiliary voltage line 131 is disposed on the passivation layer 180.

An interlayer insulating layer 80 is disposed on the auxiliary electrode 271, and the first pixel electrode 191a and the second pixel electrode 191b are disposed on the interlayer insulating layer 80.

The first pixel electrode 191a is connected to the first drain electrode 175a through a first contact hole 185a defined through the passivation layer 180 and the interlayer insulating layer 80, and the second pixel electrode 191b is connected to the second drain electrode 175b through a second contact hole 185b defined through the passivation layer 180 and the interlayer insulating layer 80.

The first pixel electrode 191a includes a lower stem 191a1 and an upper stem 191a2, and a plurality of first branches 191a3 and a plurality of second branches 191a4, which extend from the lower stem 191a1 and the upper stem 191a2, respectively. In such an embodiment, the second pixel electrode 191b includes a lower stem 191b1 and an upper stem 191b2, and a plurality of third branches 191b3 and a plurality of fourth branches 191b4, which extend from the lower stem 191b1 and the upper stem 191b2, respectively.

Next, the upper panel 200 will be described.

In such an embodiment, the upper panel 200 includes a second insulation substrate 201, a light blocking member 220 disposed on a second insulation substrate 210, a plurality of color filters 230 disposed on the second insulation substrate 210 and the light blocking member 220, and an overcoat 250 disposed on the color filter 230 and the light blocking member 220.

A common electrode 270 is disposed on the overcoat 250, and an insulating layer 280 is disposed on the common electrode 270.

In such an embodiment, the insulating layer 280 reduces an effect of the common voltage on a horizontal electric field applied between the first pixel electrode 191a and the second pixel electrode 191b by reducing an effect of a common voltage applied to the common electrode 270.

Alignment layers (not illustrated) may be coated on inner surfaces of the lower panel 100 and the upper panel 200, and the alignment layer may be a vertical alignment layer. At least one of the alignment layer and the liquid crystal layer 3 may include a photopolymerized polymer layer.

Polarizers (not illustrated) may be provided on outer surfaces of the lower panel 100 and the upper panel 200.

The liquid crystal layer 3 interposed between the lower panel 100 and the upper panel 200 includes liquid crystal molecules 31 having positive dielectric anisotropy, and the liquid crystal molecules 31 may be aligned in a predetermined direction such that longitudinal axes thereof are substantially vertical to the surfaces of the two display panels 100 and 200 while an electric field is not applied therein.

Other features of the exemplary embodiment of the liquid crystal display shown in FIGS. 12 and 13 is substantially the same as the exemplary embodiment described above with reference to FIGS. 1 to 4 and the exemplary embodiment described above with reference to FIGS. 5 to 7, and any repetitive detailed description thereof will hereinafter be omitted.

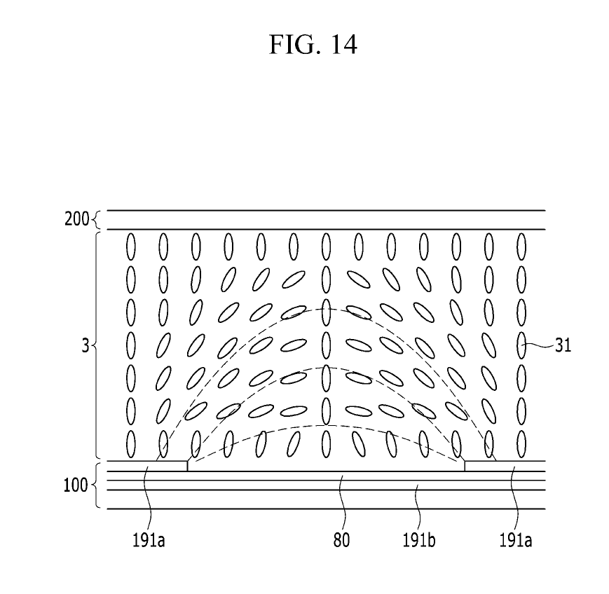

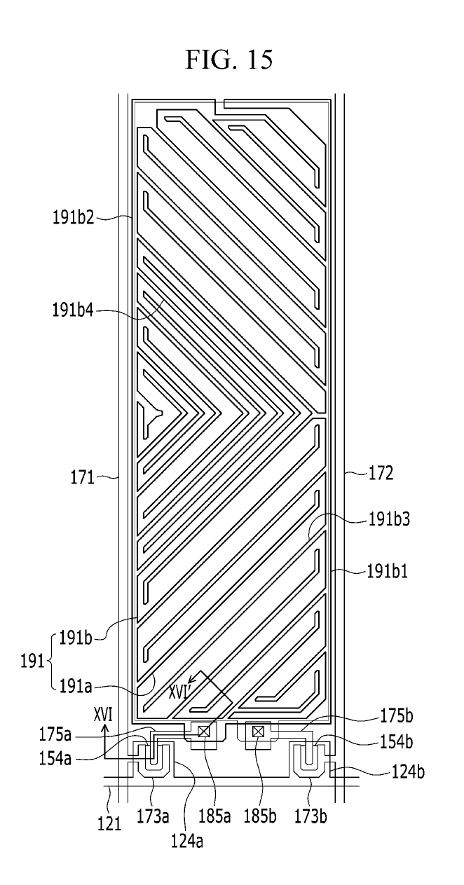

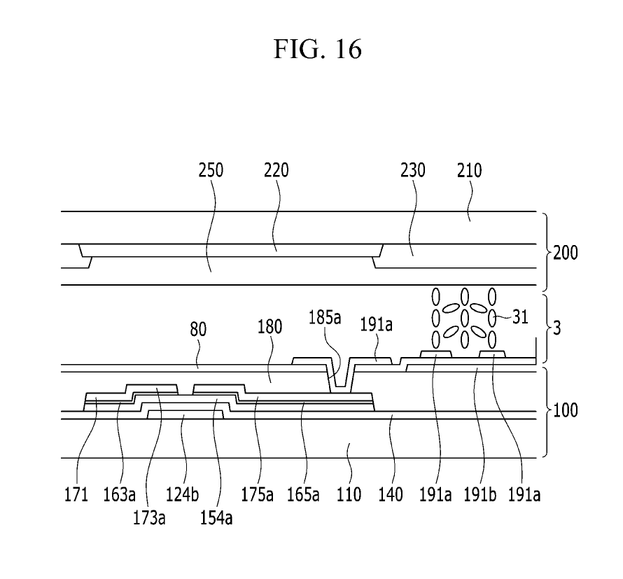

Then, another alternative exemplary embodiment of a liquid crystal display according to the invention will be described with reference to FIGS. 14 to 16. FIG. 14 is a schematic cross-sectional view of another alternative exemplary embodiment of a liquid crystal display according the invention, FIG. 15 is a top plan view of another alternative exemplary embodiment of a liquid crystal display according to the invention, and FIG. 16 is a cross-sectional view taken along line XVI-XVI′ of the liquid crystal display of FIG. 15.

The liquid crystal display in FIGS. 14 to 16 is substantially the same as the liquid crystal display shown in FIGS. 5 to 7 except for the common electrode 270. The same or like elements shown in FIGS. 14 to 16 have been labeled with the same reference characters as used above to describe the exemplary embodiments of the liquid crystal display shown in FIGS. 5 to 7, and any repetitive detailed description thereof may be omitted or simplified.

Referring to FIG. 14, an exemplary embodiment of a liquid crystal display includes two display panels, e.g., a lower panel 100 and an upper panel 200, disposed opposite to each other, and a liquid crystal layer 3 interposed between the two display panels 100 and 200.

In such an embodiment, a first pixel electrode 191a and a second pixel electrode 191b are disposed on the lower panel 100. The first pixel electrode 191a and the second pixel electrode 191b are positioned in each pixel area.

The first pixel electrode 191a of the first pixel electrode 191a and the second pixel electrode 191b includes a plurality of branches, and the second pixel electrode 191b may have a planar shape which may substantially covers an entire pixel area. An interlayer insulating layer 80 is disposed between the first pixel electrode 191a and the second pixel electrode 191b. In such an embodiment, the interlayer insulating layer 80 may be positioned below the first pixel electrode 191a and above the second pixel electrode 191b.

In an exemplary embodiment of the liquid crystal display, as shown in FIGS. 14 to 16, the common electrode 270 is not provided on the upper panel 200.

The liquid crystal layer 3 has positive dielectric anisotropy, and the liquid crystal molecules of the liquid crystal layer 3 are aligned in a predetermined direction such that longitudinal axes thereof are substantially vertical to the surfaces of the two display panels while an electric field is not applied therein.

In such an embodiment, voltages having different polarities may be applied to the first pixel electrode 191a and the second pixel electrode 191b.

When the different voltages are applied to the first pixel electrode 191a and the second pixel electrode 191b, a potential difference is generated between the first pixel electrode 191a and the second pixel electrode 191b, and as illustrated in FIG. 14, an electric field, which is substantially parallel to the surface of the lower panel 100, is applied to the liquid crystal layer 3 between the first pixel electrode 191a and the second pixel electrode 191b. In such an embodiment, where liquid crystal molecules 31 have positive dielectric anisotropy, the liquid crystal molecules 31 are tilted such that longitudinal axes thereof are substantially parallel to a direction of the electric field, and the tilted degree varies according to a magnitude of a pixel voltage. In such an embodiment, a change degree of polarization of light passing through the liquid crystal layer 3 varies according to the tilted degree of the liquid crystal molecules 31. The change in the polarization is represented by a change in transmittance of light by a polarizer, and as a result, each pixel displays predetermined luminance corresponding to data voltage applied thereto.

As described above, in an exemplary embodiment of the liquid crystal display, the interlayer insulating layer 80 is disposed between the first pixel electrode 191a and the second pixel electrode 191b, and the first pixel electrode 191a includes a plurality of branches, and the second pixel electrode 191b has a planar shape. The interlayer insulating layer 80 may be positioned below the first pixel electrode 191a and above the second pixel electrode 191b.

The structure of the exemplary embodiment of the liquid crystal display shown in FIGS. 15 and 16 is similar to the structure of the exemplary embodiment of the liquid crystal display illustrated in FIGS. 6 and 7.

Referring to FIGS. 15 and 16, an exemplary embodiment of the liquid crystal includes two display panels, e.g., a lower panel 100 and an upper panel 200, disposed opposite to each other, and a liquid crystal layer 3 interposed between the two display panels 100 and 200.

First, the lower panel 100 will be described.

In such an embodiment, the lower panel 100 includes a first insulation substrate 110, a gate line 121 including a first gate electrode 124a and a second gate electrode 124b and disposed on the first insulation substrate 110, and a gate insulating layer 140 disposed on the gate line 121.

A first semiconductor 154a and a second semiconductor 154b are disposed on the gate insulating layer 140, ohmic contacts 163a and 165a are disposed on the first semiconductor 154a and the second semiconductor 154b, and a data conductor including a first data line 171, a second data line 172, a first drain electrode 175a and a second drain electrode 175b is disposed on the ohmic contacts 163a and 165a and the gate insulating layer 140. The first data line 171 includes a first source electrode 173a, and the second data line 172 includes a second source electrode 173b.

A passivation layer 180 including an inorganic insulator or an organic insulator is disposed on the data conductor 171, 172, 175a and 175b and the exposed portion of the semiconductors 154a and 154b, a second pixel electrode 191b is disposed on the passivation layer 180, an interlayer insulating layer 80 is disposed on the second pixel electrode 191b, and a first pixel electrode 191a is disposed on the interlayer insulating layer 80.

The first pixel electrode 191a is connected to the first drain electrode 175a through a first contact hole 185a defined through the passivation layer 180 and the interlayer insulating layer 80, and the second pixel electrode 191b is connected to the second drain electrode 175b through a second contact hole 185b defined through the passivation layer 180.

The first pixel electrode 191a includes a lower stem 191a1 and an upper stem 191a2, and a plurality of first branches 191a3 and a plurality of second branches 191a4, which extend from the lower stem 191a1 and the upper stem 191a2, respectively, and the second pixel electrode 191b has a planar shape.

Next, the upper panel 200 will be described.

In an exemplary embodiment, as shown in FIGS. 15 and 16, the upper panel 200 includes a second insulation substrate 210, a light blocking member 220 disposed on the second insulation substrate 210, a plurality of color filters 230 disposed on the second insulation substrate 210 and the light blocking member 220, and an overcoat 250 disposed on the color filter 230 and the light blocking member 220.

Alignment layers (not illustrated) may be coated on inner surfaces of the lower panel 100 and the upper panel 200, and the alignment layer may be a vertical alignment layer. At least one of the alignment layer and the liquid crystal layer 3 may include a photopolymerized polymer layer.

Polarizers (not illustrated) may be provided on outer surfaces of the lower panel 100 and the upper panel 200.

The liquid crystal layer 3 interposed between the lower panel 100 and the upper panel 200 includes liquid crystal molecules 31 having positive dielectric anisotropy, and the liquid crystal molecules 31 may be aligned in a predetermined direction such that longitudinal axes thereof are substantially vertical to the surfaces of the two display panels 100 and 200 while an electric field is not applied therein.

Other features of the exemplary embodiment of the liquid crystal display shown in FIGS. 14 to 16 is substantially the same as the exemplary embodiment described above with reference to FIGS. 5 to 7, and any repetitive detailed description thereof will hereinafter be omitted.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display, comprising:
a first substrate;
a second substrate disposed opposite to the first substrate;
a liquid crystal layer interposed between the first substrate and the second substrate, and comprising liquid crystal molecules;
a first pixel electrode and a second pixel electrode, which are disposed on the first substrate, spaced apart from each other, and disposed in a same pixel area;
a common electrode disposed on the second substrate; and
an insulating layer disposed on the common electrode,
wherein
the liquid crystal molecules are aligned substantially vertical to a surface of the first substrate and a surface of the second substrate when an electric field is not applied thereto, and
the liquid crystal molecules have positive dielectric anisotropy.

2. The liquid crystal display of claim 1, wherein
the first pixel electrode comprises a plurality of first branch electrodes,
the second pixel electrodes comprises a plurality of second branch electrodes,
the plurality of first branch electrodes and the plurality of second branch electrodes are alternately disposed with each other, and
the first pixel electrode and the second pixel electrode are disposed in a same layer as each other.

3. The liquid crystal display of claim 2, wherein
the first pixel electrode and the second pixel electrode receive voltages having different polarities from each other.

4. The liquid crystal display of claim 2, further comprising:
an auxiliary electrode disposed below the first pixel electrode and the second pixel electrode; and
an interlayer insulating layer disposed between the first pixel electrode and the second pixel electrode, and the auxiliary electrode.

5. The liquid crystal display of claim 4, wherein
the auxiliary electrode receives a voltage having a predetermined magnitude, which is different from a magnitude of a voltage applied to the common electrode.

6. The liquid crystal display of claim 5, wherein
the auxiliary electrode has a planar shape.

7. The liquid crystal display of claim 1, further comprising:
an interlayer insulating layer disposed between the first pixel electrode and the second pixel electrode,
wherein
the first pixel electrode comprises a plurality of first branch electrodes,
the second pixel electrode comprises a plurality of second branch electrodes, and
the plurality of first branch electrodes and the plurality of second branch electrodes are alternately disposed with each other.

8. The liquid crystal display of claim 7, wherein
the first pixel electrode and the second pixel electrode receive voltages having different polarities from each other.

9. The liquid crystal display of claim 7, further comprising:
an auxiliary electrode disposed below the first pixel electrode and the second pixel electrode; and
an additional interlayer insulating layer disposed between the first pixel electrode and the second pixel electrode, and the auxiliary electrode.

10. The liquid crystal display of claim 9, wherein
the auxiliary electrode receives a voltage having a predetermined magnitude, which is different from a magnitude of a voltage applied to the common electrode.

11. The liquid crystal display of claim 10, wherein
the auxiliary electrode has a planar shape.

12. The liquid crystal display of claim 1, further comprising:
an interlayer insulating layer disposed between the first pixel electrode and the second pixel electrode,
wherein
one of the first pixel electrode and the second pixel electrode comprises a plurality of first branch electrodes, and
the other of the first pixel electrode and the second pixel electrode has a planar shape, and
the plurality of branch electrodes is disposed on the interlayer insulating layer.

13. The liquid crystal display of claim 12, wherein
the first pixel electrode and the second pixel electrode receive voltages having different polarities from each other.

14. A liquid crystal display comprising:
a first substrate;
a second substrate disposed opposite to the first substrate;
a liquid crystal layer interposed between the first substrate and the second substrate, and comprising liquid crystal molecules;
a first pixel electrode and a second pixel electrode, which are disposed on the first substrate, spaced apart from each other, and disposed in a same pixel area; and
an interlayer insulating layer disposed between the first pixel electrode and the second pixel electrode,
wherein
one of the first pixel electrode and the second pixel electrode comprises a plurality of first branch electrodes,
the other of the first pixel electrode and the second pixel electrode has a planar shape,
the liquid crystal molecules are aligned substantially vertical to a surface of the first substrate and a surface of the second substrate when an electric field is not applied thereto, and
the liquid crystal molecules have positive dielectric anisotropy.

15. The liquid crystal display of claim 14, wherein
the first pixel electrode and the second pixel electrode receive voltages having different polarities from each other.
